(19) United States
(12) Patent Application Publication
(10) Pub. No.: US 2021/0291274 A1
(43) Pub. Date: Sep. 23, 2021

(54) INFILTRATABLE STRUCTURES

(71) Applicant: Desktop Metal, Inc., Burlington, MA (US)

(72) Inventors: Timothy Sercombe, Burlington, MA (US); Michael Andrew Gibson, Philadelphia, PA (US); Ellen Elizabeth Benn, Cambridge, MA (US)

(73) Assignee: Desktop Metal, Inc., Burlington, MA (US)

(21) Appl. No.: 17/264,253

(22) PCT Filed: Jul. 15, 2019
(86) PCT No.: PCT/US2019/041697

§ 371 Date: Jan. 28, 2021

Related U.S. Application Data
(60) Provisional application No. 62/697,886, filed on Jul. 13, 2018.

(51) Int. Cl. B22F 10/14; B33Y 10/00; B33Y 80/00; B22F 10/34

(52) U.S. Cl. CPC B22F 10/14; B33Y 10/00; B33Y 80/00; B22F 2207/17; B22F 2999/00; B22F 2301/052; B22F 10/34

(57) ABSTRACT

A method for fabricating an infiltrated object of a desired shape having a high volume fraction of infiltrant using an additively manufactured preform. Using an additive manufacturing technique, the preform is formed with graded macro-porosity. When infiltrated, the void volume of the macro-porosity is filled with infiltrant Optionally, the void volume may be varied across the profile of the object to create a gradient of mechanical properties in the infiltrated object.

### FIELD OF THE DISCLOSURE

The subject matter of the present disclosure generally relates to metal infiltration, and more particularly relates to infiltration of three-dimensional structures having grated macro-porosity.

### BACKGROUND OF THE DISCLOSURE

Metal infiltration is a processing technique by which a preform of one metal or alloy is infiltrated with a liquid infiltrant of a different metal or alloy to fill void space in the preform to create a final densified part. There are various material systems for the preform material and the infiltrant that are known in the art. It is desirable in certain instances to fabricate a preform for infiltration using three-dimensional printing processes as these processes provide excellent ability to accommodate varying part geometries, rapid prototyping and generally avoid the need for molds, which are expensive and limit part geometry. There are however certain difficulties that may be encountered in doing.

In infiltrated structures, the infiltrant and the preform material often have fairly different mechanical properties because the infiltrant typically must have a lower melting point than the preform to avoid dissolving the preform. Thus, the infiltrant is usually of lower strength, hardness and/or stiffness. As a result, the properties of the resulting material are dictated largely by the ratio of the two phases—the ratio of the infiltrant phase to the preform phase. Unfortunately, it is often difficult to independently control the ratio of the two phases when formulating the preform using additive manufacturing processes for reasons now described.

Take for example the infiltration of a preform fabricated using a powder bed additive manufacturing process. To form the preform powders are spread layer-by-layer, with binder jetted from a print head to define the preform geometry. After the preform is formed, loose powder around the preform is removed and much of the binder is removed. In an emblematic aluminum-aluminum infiltration system, the aluminum preform is then nitrided to form an aluminum nitride skeleton. The aluminum nitride preform may then be infiltrated with liquid aluminum, which has a lower melting temperature than the aluminum nitride. This nitriding and infiltration process is described in U.S. Pat. No. 7,036,550 entitled “Infiltrated Aluminum Preforms” and filed Mar. 15, 2004, the entire contents of which are incorporated by reference herein.

In a powder bed additive manufacturing process as described above, the apparent density of the powder is the density returned by measuring the volume occupied by a known mass of powder flowed freely into a standardized measuring device. The tap density of the powder is the density returned as the result of flowing an amount of powder into a graduated cylinder which is then mechanically tapped until further volume reduction is minimalized. The volume fraction of the preform material printed must, by virtue of the layer-by-layer spreading, fall between the apparent density of the powder and the tap density of the powder.

Some powders can be spread to either above or below this range, but this generally defines the range that can be achieved. For the flowable powders typically used in powder bed additive manufacturing processes, the apparent densities are typically greater than 54 percent by volume, and the tap densities are typically less than 65 percent by volume. This range, 54-63 percent, represents a very small fraction of potential design space and limits the maximum volume fraction of infiltrant. A result of this confined volume fraction range is a confined range of properties that may be achieved by the resulting composites for a given infiltrant and preform composition. It is desirable to be able to engineer a wider range of properties in such composites, and thus techniques to expand the available volume fractions range are desirable.

Similar volume fraction constraints exist for other additive manufacturing techniques such as thermoplastic extrusion of bound metal composites due to rheological concerns and concerns regarding packing and dimensional stability of the structures during the thermal processing required by such methods.

As an example of the result of such difficulties, in the aluminum-aluminum infiltration system described above, the aluminum nitride has a large difference in mechanical properties as compared to the aluminum infiltrant. Normally, one would tune the properties of the composite by adjusting the volume fraction of each. However, the above described limited volume fraction range restricts the tuning and thus mechanical properties that can be accomplished.

In certain situations, it is further advantageous or desired to vary the volume fraction of infiltrant over the course of geometry. For example, a higher volume fraction of infiltrant may be desirable at one end of a part to increase ductility, while a lower volume fraction of infiltrant is desired at the other end of a part to increase tensile strength.

Further techniques and disclosure related to infiltration can be found in U.S. Patent Publication No. 2018/0305266-A1 titled “Additive Fabrication of Infiltrable Structures” and filed Apr. 24, 2018, the entire contents of which are incorporated herein in their entirety.

The subject matter of the present disclosure is directed to overcoming, or at least reducing the effects of, one or more of the problems set forth above.

### BRIEF SUMMARY OF THE DISCLOSURE

Disclosed is method of fabricating an infiltrated part including selective areas having a high volume fraction of infiltrant.

The manufacturing process for a three-dimensional object of a desired shape begins with the forming of a build material into a skeleton, the build material including a metal powder and a binder system. The skeleton includes graded macro-porosity having a void volume. The binder system is at least partially debinded and the skeleton infiltrated with an infiltrant. The infiltrant occupies the void volume of the macro-porosity.

In certain areas portions of the object, the volume fraction of micro-porosity may be increased relative to other portions of the object, creating an object having a varied infiltrant volume fraction gradient and thus a gradient of mechanical properties.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIGS. 1A-D depict a bound metal deposition system for use in forming build material into a skeleton.

FIGS. 2A-C depict a powder bed binder jetting system for use in forming build material into a skeleton.

FIG. 3 depicts a flow chart of an embodiment method.

FIG. 4A depicts a cross section of an embodiment skeleton having graded macro-porosity.

FIG. 4B depicts a cross section of an embodiment skeleton having graded macro-porosity that varies over an axis of the object.

FIGS. 5A-C depict an embodiment macro-porosity structure for use as an infill pattern in embodiment skeletons.

FIGS. 6A-B depict another embodiment macro-porosity structure for use as an infill pattern in embodiment skeletons.

FIGS. 7A-B depict another embodiment macro-porosity structure for use in embodiment skeletons.

FIGS. 8A-E are graphs of powder sizes for an experiment regarding the infiltration of aluminum preforms.

FIGS. 9A-E depict scanning electron images of powders used in the experiment.

FIGS. 10A-B depict preform bars manufactured from the powders used in the experiment.

FIGS. 11A-B depict a furnace setup as used in the experiment.

FIGS. 12A-C depict the infiltration setup as used in the experiment.

FIG. 13 depicts the process of infiltration for the experiment.

FIG. 14 depicts a nitriding profile as used in the experiment.

FIGS. 15A-B depict the nitriding process as used in the experiment.

FIGS. 16A-D depict the weight gains encountered during the nitriding process in the experiment.

FIGS. 17A-D depict the microstructure of the powders after nitriding.

FIGS. 18 depicts densities achieved given various gas profiles used in the experiment.

FIGS. 19A-C depict the microstructure of infiltrated structures for various lengths of nitridation.

FIG. 20 depicts the densities achieved using various amounts of infiltrant.

FIG. 21 depicts the structure of an infiltrated part in the experiment.

FIG. 22 depicts the elemental distribution in a final part produced in the experiment.

FIG. 23 depicts the hardness achieved for various nitridation periods in the experiment.

FIGS. 24A-B depict tensile properties for structures made in the experiment.

FIG. 25 depicts the mechanical properties of structures made in the experiment.

FIG. 26 depicts a structure having macro-porosity channels for infiltration in the experiment.

FIG. 27 depicts the mechanical strength of objects as a function of the time of nitridation.

FIG. 28 depicts the electrical conductivity of objects manufactured during the experiment.

FIG. 29 depicts an additively manufactured impeller infiltrated during the experiment.

FIGS. 30A-B detail the part qualities observed during the experiment.

Like reference numbers and designations in the various drawings indicate like elements.

### DETAILED DESCRIPTION

In general, by controlling an additive manufacturing process used to form an initial structure, a skeleton formed from the initial structure may define an interconnected porous network having controlled (e.g., graded) macro-porosity. As described in greater detail below, the controlled macro-porosity may be graded along the skeleton (e.g., having a predetermined variation in macro-porosity along one or more dimensions of the skeleton). Such graded macro-porosity may be useful, for example, for facilitating appropriate structural strength of the skeleton, with a lower amount of macro-porosity along portions of the skeleton requiring more support (e.g., toward the bottom of a part, overhanging features or fine details) and higher amounts of macro-porosity along portions of the skeleton requiring less support (e.g., toward the top of a part). As also described in greater detail below, infiltration of the skeleton with an infiltration material may advantageously produce a finished part having a predetermined spatial variation in material properties.

As used herein, the term “macro-porosity” should be understood to refer to pores having a smallest dimension larger than an average size of the particles of the metal powder used to form the skeleton. Thus, for example, in instances in which the average size of the particles is 20 microns, macro-porosity refers to pores having a smallest dimension greater than 20 microns. Further, macro-porosity should be understood to be distinguished from “micro-porosity,” which refers to the porosity having a smallest dimension less than the average particle size of the particles of the metal powder and is formed in the void between contacting particles of the metal powder. As a general principle, macro-porosity may be introduced into the skeleton through controlling one or more parameters of an additive manufacturing process while micro-porosity is largely a function of the average particle size of the particles used to form the skeleton.

In general, unless otherwise specified or made clear from the context, any one or more of the various different additive manufacturing techniques described herein may be used to form the initial structure with features that result in a target distribution of macro-porosity (e.g., graded macro-porosity) in the skeleton formed from the initial structure. For example, in the case of bound metal deposition, tracks of the build material may be manipulated to form the initial structure with features that result in the target distribution of macro-porosity in the skeleton formed from the initial structure. Additionally, or alternatively, in the case of powder bed binder jetting, droplet size, saturation, or a combination thereof may be controlled to control macro-porosity in the skeleton formed from the initial structure. That is, as compared to smaller droplets, the use of larger droplets may create larger capillary forces that pull the powder particles toward one another in the initial structure—a condition that is a precursor to increased macro-porosity in the skeleton. Accordingly, in instances in which the initial structure is formed through binder jetting, graded macro-porosity may be achieved in the corresponding skeleton by controlling droplet size in the binder jetting process used to form the initial structure. More generally, macro-porosity of the skeleton may be controlled by controlling surface tension of the binder delivered to a top layer of a powder bed during a binder jetting process. While the control of such surface tension has been described as being a function of the one or more of droplet size and saturation, it should be appreciated that such surface tension may further or instead be controlled through the addition of one or more other materials (e.g., moisture) to the surface to control surface tension forces of the binder.

Densification of the initial structure to form the skeleton may be carried out according to any one or more of various techniques (e.g., thermal, chemical, or a combination thereof) useful for removing one or more components of a binder system and sintering metal particles to one another. For example, unless otherwise specified or made clear from the context, densification may be carried out using any one or more of the various densification techniques described herein. In an aluminum system where an aluminum skeleton is nitrided, the skeleton may be partially sintered to form a substantially stable structure prior to infiltration.

In certain implementations, the initial structure may be additively manufactured using a first metal alloy and densified through post processing to form the skeleton defining the interconnected porous network having graded macro-porosity. The skeleton may be infiltrated with a second metal alloy, different from the first metal alloy, such that the resultant infilled composite structure has a gradient of the first metal alloy (used to form the skeleton) and the second metal alloy (used as the infiltration material). Thus, to the extent the first metal alloy and the second metal alloy have different material properties, it should be generally understood that infiltration of the graded macro-porosity of the skeleton by the second metal alloy may facilitate formation of parts having spatially-varying material properties. That is, where a higher concentration of the second metal alloy is desirable in a particular area or along a particular axis, the corresponding portion of the skeleton may define a higher volume fraction of macro-porosity.

As an example, the use of a skeleton defining graded macro-porosity may be used to form aluminum parts having spatial variations in material properties. Forming aluminum-alloy parts using powdered metal additive manufacturing processes can be challenge primarily due to poor sinterability attributable to the oxide layer that forms on the skin of the aluminum alloy surface. This skin is difficult to reduce and generally hinders the sintering process which, in turn, adversely impacts the ability to form dense aluminum parts. However, as described in greater detail below, densification of aluminum-based parts through infiltration is generally not subject to the challenges associated with sintering aluminum-based parts and, therefore, may facilitate formation of dense aluminum parts.

In certain implementations, the initial structure may include a first aluminum-based material held together with a binder. The skeleton may be formed, for example, by removing the binder and sintering the initial structure to near full density using a nitrogen atmosphere. Continuing with this example, the resulting skeleton may be a dense, complex-shaped three-dimensional structure having graded macro-porosity, and the surface of the skeleton may have some aluminum-nitrided structure. This skeleton may be infiltrated with a second aluminum-based material, different from the first aluminum-based material. Because the distribution of second aluminum-based material follows the graded macro-porosity, the resulting part should be understood to have a graded distribution of the first aluminum-based material and the second aluminum-based material.

In general, the first aluminum-based material and the second aluminum-based material may be any one or more of various aluminum-based materials compatible with one another in the formation of a structure and having at least one different physicochemical property. The first aluminum-based material may include an aluminum alloy or an aluminum alloy-based composite structure. Similarly, the second aluminum-based material may include an aluminum alloy or an aluminum alloy-based composite structure. As an example, an aluminum alloy useful as the second aluminum-based material is Al-10Si alloy.

While the infiltratable structures have been described as being formed using a first aluminum-based material and a second aluminum-based material, unless otherwise specified or made clear from the context, it should be generally understood that any of the techniques associated with infiltratable structures described herein may be used with any combination of materials that may be usable in combination as a skeleton and an infiltratable material.

While infiltration may be carried out with a part under normal atmospheric pressure, other conditions may further or instead facilitate infiltration of an infiltration material into a skeleton defining an interconnected porous network. For example, the infiltration of the skeleton may be carried out in a furnace under vacuum conditions (e.g., a partial vacuum). As compared to infiltration in air under normal atmospheric pressure, infiltration under vacuum conditions may be useful for achieving improved penetration of the infiltration material into the skeleton. Additionally, or alternatively, infiltration of the infiltration material into the skeleton may be carried out in a pressurized furnace. Infiltration under such pressurized conditions may be useful for achieving faster penetration of the infiltration material into the skeleton, particularly in instances in which the skeleton has large pores.

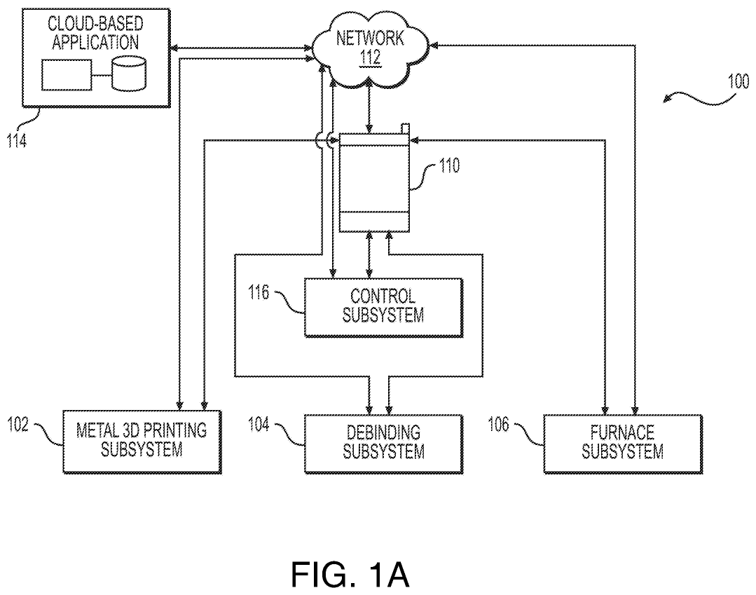

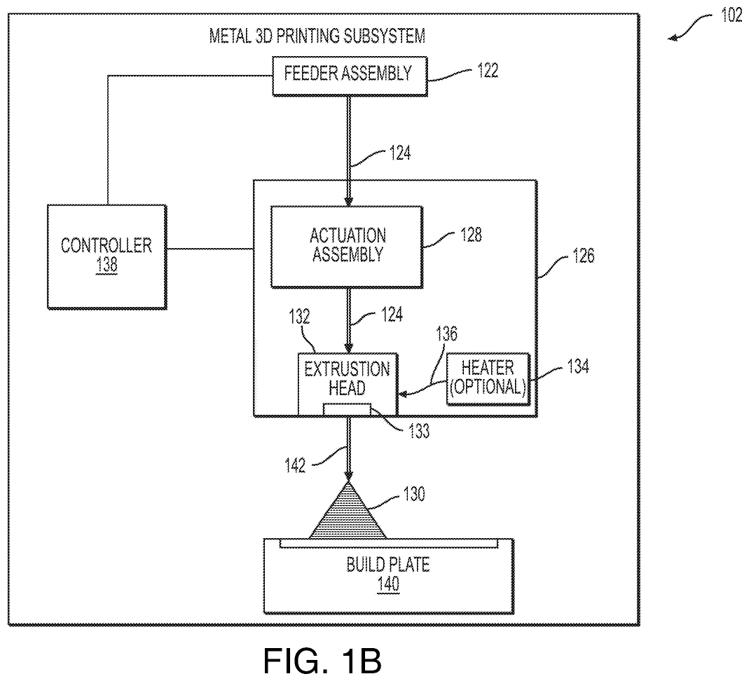

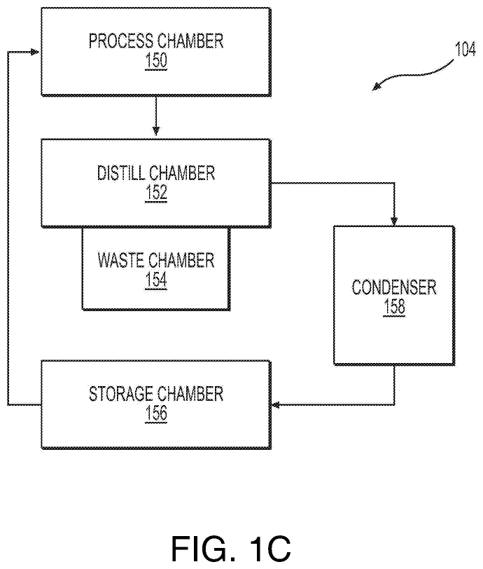

FIG. 1A illustrates an exemplary system 100 for forming a printed object, according to an embodiment of the present disclosure. System 100 may include a three-dimensional (3D) printer, for example, a metal 3D printing subsystem 102, and one or more treatment site(s), for example, a debinding subsystem 104 and a furnace subsystem 106, for treating the green part after printing. Metal 3D printing subsystem 102 may be used to form an object from a build material, for example, by depositing successive layers of the build material onto a build plate. The build material may include metal powder and at least one binder material. In some embodiments, the build material may include a primary binder material (e.g., a wax) and a secondary binder material (e.g., a polymer). A binder system may include a single binder or a primary binder and a secondary binder.

Debinding subsystem 104 may be configured to treat the printed object by performing a first debinding process, in which the primary binder material may be removed. In some embodiments, the first debinding process may be a chemical debinding process, as will be described in further detail with reference to FIG. 1C. In such embodiments, the primary binder material may dissolve in a debinding fluid while the secondary binder material remains, holding the metal particles in place in their printed form.

In other embodiments, the first debinding process may comprise a thermal debinding process. In such embodiments, the primary binder material may have a vaporization temperature lower than that of the secondary binder material. The debinding subsystem 104 may be configured to heat the deposited build material to a temperature at or above the vaporization temperature of the primary binder material and below the vaporization temperature of the secondary binder material such that the primary binder material is removed from the printed part. In alternative embodiments, the furnace subsystem 106 rather than a separate heating debinding subsystem 104 may be configured to perform the first debinding process. For example, the furnace subsystem 106 may be configured to heat the deposited build material to a temperature at or above the vaporization temperature of the primary binder material and below the vaporization temperature of the secondary binder material such that the primary binder material is removed from the deposited build material.

Furnace subsystem 106 may be configured to treat the printed object by performing a secondary thermal debinding process (or also a primary debinding process, as in the alternative embodiment described above), in which the secondary binder material and/or any remaining primary binder material may be vaporized and removed from the printed part. In some embodiments, the secondary debinding process may comprise a thermal debinding process, in which the furnace subsystem 106 may be configured to heat the part to a temperature at or above the vaporization temperature of the secondary binder material to remove the secondary binder material. The furnace subsystem 106 may then heat the part to a temperature just below the melting point of the metal powder to sinter the metal powder and to densify the metal powder into a solid metal part.

As shown in FIG. 1A, system 100 may also include a user interface 110, which may be operatively coupled to one or more components, for example, to metal 3D printing subsystem 102, debinding subsystem 104, and furnace subsystem 106, etc. In some embodiments, user interface 110 may be a remote device (e.g., a computer, a tablet, a smartphone, a laptop, etc.) or an interface incorporated into system 100, e.g., on one or more of the components. User interface 110 may be wired or wirelessly connected to one or more of metal 3D printing subsystem 102, debinding subsystem 104, and/or furnace subsystem 106. System 100 may also include a control subsystem 116, which may be included in user interface 110, or may be a separate element.

Metal 3D printing subsystem 102, debinding subsystem 104, furnace subsystem 106, user interface 110, and/or control subsystem 116 may each be connected to the other components of system 100 directly or via a network 112. Network 112 may include the Internet and may provide communication through one or more computers, servers, and/or handheld mobile devices, including the various components of system 100. For example, network 112 may provide a data transfer connection between the various components, permitting transfer of data including, e.g., part geometries, printing material, one or more support and/or support interface details, printing instructions, binder materials, heating and/or sintering times and temperatures, etc., for one or more parts or one or more parts to be printed.

Moreover, network 112 may be connected to a cloud-based application 114, which may also provide a data transfer connection between the various components and cloud-based application 114 in order to provide a data transfer connection, as discussed above. Cloud-based application 114 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of metal 3D printing subsystem 102, debinding subsystem 104, sintering furnace subsystem 106, user interface 110, and/or control subsystem 116. In this aspect, metal 3D printing subsystem 102, debinding subsystem 104, furnace subsystem 106, user interface 110, and/or control subsystem 116 may be disconnected from the Internet and/or other networks, which may increase security protections for the components of system 100. In either aspect, an additional controller (not shown) may be associated with one or more of metal 3D printing subsystem 102, debinding subsystem 104, and furnace subsystem 106, etc., and may be configured to receive instructions to form the printed object and to instruct one or more components of system 100 to form the printed object.

FIG. 1B is a block diagram of a metal 3D printing subsystem 102 according to one embodiment. The metal 3D printing subsystem 102 may extrude build material 124 to form a three-dimensional part. As described above, the build material may include a mixture of metal powder and binder material. For example, the build material may include any combination of metal powder, plastics, wax, ceramics, polymers, among others. In some embodiments, the build material 124 may come in the form of a rod comprising a predetermined composition of metal powder and one or more binder components (e.g., a primary and a secondary binder).

Metal 3D printing subsystem 102 may include an extrusion assembly 126 comprising an extrusion head 132. Metal 3D printing subsystem 102 may include an actuation assembly 128 configured to propel the build material 124 into the extrusion head 132. For example, the actuation assembly 128 may be configured to propel the build material 124 in a rod form into the extrusion head 132. In some embodiments, the build material 124 may be continuously provided from the feeder assembly 122 to the actuation assembly 128, which in turn propels the build material 124 into the extrusion head 132. In some embodiments, the actuation assembly 128 may employ a linear actuation to continuously grip and/or push the build material 124 from the feeder assembly 122 towards the extrusion head 132.

In some embodiments, the metal 3D printing subsystem 102 includes a heater 134 configured to generate heat 136 such that the build material 124 propelled into the extrusion head 132 may be heated to a workable state. In some embodiments, the heated build material 124 may be extruded through a nozzle 133 to extrude workable build material 142 onto a build plate 140. It is understood that the heater 134 is an exemplary device for generating heat 136, and that heat 136 may be generated in any suitable way, e.g., via friction of the build material 124 interacting with the extrusion assembly 126, in alternative embodiments. While there is one nozzle 133 shown in FIG. 1B, it is understood that the extrusion assembly 126 may comprise more than one nozzle in other embodiments. In some embodiments, the metal 3D printing subsystem 102 may include another extrusion assembly (not shown in FIG. 1B) configured to extrude a non-sintering ceramic material onto the build plate 140.

In some embodiments, the metal 3D printing subsystem 102 comprises a controller 138. The controller 138 may be configured to position the nozzle 133 along an extrusion path relative to the build plate 140 such that the workable build material is deposited on the build plate 140 to fabricate a three dimensional printed object 130. The controller 138 may be configured to manage operation of the metal 3D printing subsystem 102 to fabricate the printed object 130 according to a three-dimensional model. In some embodiments, the controller 138 may be remote or local to the metallic printing subsystem 102. The controller 138 may be a centralized or distributed system. In some embodiments, the controller 138 may be configured to control a feeder assembly 122 to dispense the build material 124. In some embodiments, the controller 138 may be configured to control the extrusion assembly 126, e.g., the actuation assembly 128, the heater 134, the extrusion head 132, and/or the nozzle 133. In some embodiments, the controller 138 may be included in the control subsystem 116.

FIG. 1C depicts a block diagram of a debinder subsystem 104 for debinding a printed object 130 according to one embodiment. The debinder subsystem 104 may include a process chamber 150, into which the printed object 130 may be inserted for a first debinding process. In some embodiments, the first debinding process may be a chemical debinding process. In such embodiments, the debinder subsystem 104 may include a storage chamber 156 to store a volume of debinding fluid, e.g., a solvent, for use in the first debinding process. The storage chamber 156 may comprise a port which may be used to fill, refill, and/or drain the storage chamber 156 with the debinding fluid. In some embodiments, the storage chamber 156 may be removably attached to the debinder subsystem 104. In such embodiments, the storage chamber 156 may be removed and replaced with a replacement storage chamber (not shown in FIG. 1C) to replenish the debinding fluid in the debinding subsystem 104. In some embodiments, the storage chamber 156 may be removed, refilled with debinding fluid, and reattached to the debinding subsystem 104.

The debinding fluid contained in the storage chamber 156 may be directed to the process chamber 150 containing the inserted printed object 130. In some embodiments, the build material that the printed object 130 is formed of may include a primary binder material and a secondary binder material. In some embodiments, the printed object 130 in the process chamber 150 may be submerged in the debinding fluid for a predetermined period of time. In such embodiments, the primary binder material may dissolve in the debinding fluid while the secondary binder material stays intact.

In some embodiments, the debinding fluid containing the dissolved primary binder material (hereinafter referred to as “used debinding fluid”) may be directed to a distill chamber 152. For example, after the first debinding process, the process chamber 150 may be drained of the used debinding fluid, and the used debinding fluid may be directed to the distill chamber 152. In some embodiments, the distill chamber 152 may be configured to distill the used debinding fluid. In some embodiments, the debinding subsystem 104 may further include a waste chamber 154 fluidly coupled to the distill chamber 152. In such embodiments, the waste chamber may collect waste accumulated in the distill chamber 152 as a result of the distillation. In some embodiments, the waste chamber 154 may be removably attached to the debinding subsystem 104 such that the waste chamber 154 may be removed and replaced after a number of distillation cycles. In some embodiments, the debinding subsystem 104 may include a condenser 158 configured to condense vaporized used debinding fluid from the distill chamber 152 and return the debinding fluid back to the storage chamber 156.

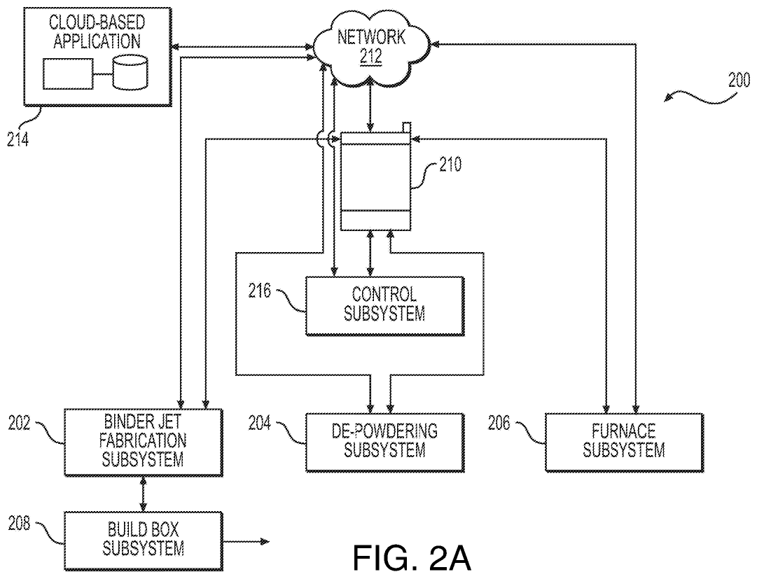

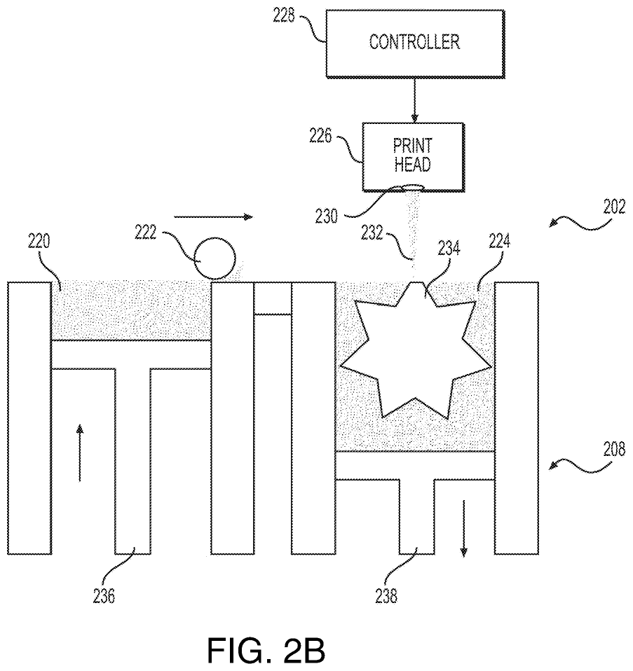

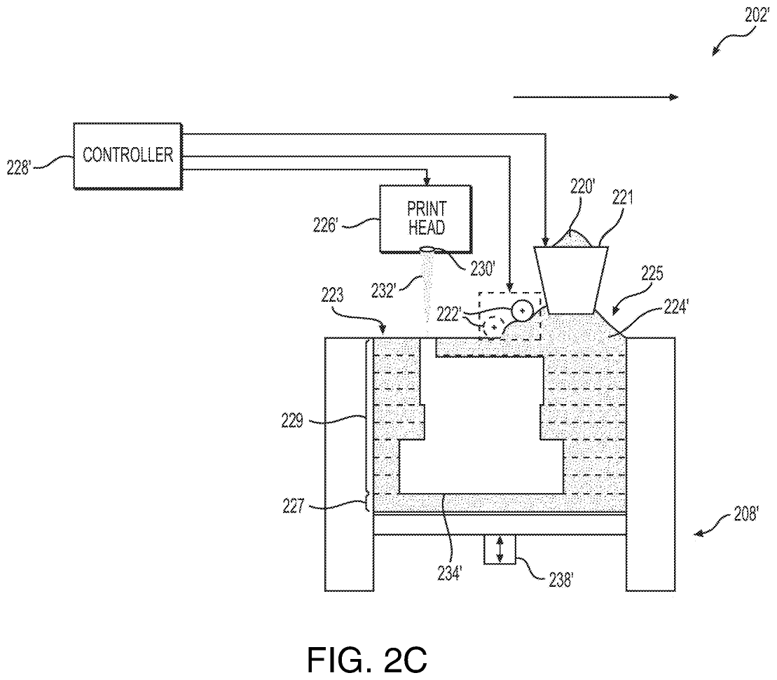

FIG. 2A illustrates another exemplary system 200 for forming a printed object, according to an embodiment of the present disclosure. System 200 may include a printer, for example, a binder jet fabrication subsystem 202, and a treatment site(s), for example, a de-powdering subsystem 204 and the furnace subsystem 106 as described with reference to FIG. 1A. Binder jet fabrication subsystem 202 may be used to form an object from a build material, for example, by delivering successive layers of build material and binder material to a build plate. As shown in FIG. 2A, a build box subsystem 208 may be movable and may be selectively positioned in one or more of binder jet fabrication subsystem 202, de-powdering subsystem 204, and furnace subsystem 106. For example, build box subsystem 208 may be coupled or couplable to a movable assembly. Alternatively, a conveyor (not shown) may help transport the object between portions of system 200.

The build material may be a bulk metallic powder delivered and spread in successive layers. The binder material may be, for example, a polymeric liquid that may be deposited onto and may be absorbed into layers of the build material. One or more of binder jet fabrication subsystem 202, de-powdering subsystem 204, and furnace subsystem 106 may include a shaping station to shape the printed object and a debinding station to treat the printed object to remove a binder material from the build material. Furnace subsystem 106 may heat and/or sinter the build material of the printed object. System 200 may also include a user interface 210, which may be operatively coupled to one or more components, for example, to binder jet fabrication subsystem 202, de-powdering subsystem 204, and furnace subsystem 106, etc. In some embodiments, user interface 210 may be a remote device (e.g., a computer, a tablet, a smartphone, a laptop, etc.). User interface 210 may be wired or wirelessly connected to one or more of binder jet fabrication subsystem 202, de-powdering subsystem 204, and furnace subsystem 106. System 200 may also include a control subsystem 216, which may be included in user interface 210, or may be a separate element.

Binder jet fabrication subsystem 202, de-powdering subsystem 204, furnace subsystem 106, user interface 210, and/or control subsystem 216 may each be connected to the other components of system 200 directly or via a network 212. Network 212 may include the Internet and may provide communication through one or more computers, servers, and/or handheld mobile devices, including the various components of system 200. For example, network 212 may provide a data transfer connection between the various components, permitting transfer of data including, e.g., geometries, the printing material, one or more support and/or support interface details, binder materials, heating and/or sintering times and temperatures, etc., for one or more parts or one or more parts to be printed.

Moreover, network 212 may be connected to a cloud-based application 214, which may also provide a data transfer connection between the various components and cloud-based application 214 in order to provide a data transfer connection, as discussed above. Cloud-based application 214 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of binder jet fabrication subsystem 202, de-powdering subsystem 204, furnace subsystem 106, user interface 210, and/or control subsystem 216. In this aspect, binder jet fabrication subsystem 202, de-powdering subsystem 204, furnace subsystem 106, user interface 210, and/or control subsystem 216 may be disconnected from the Internet and/or other networks, which may increase security protections for the components of system 200. In either aspect, an additional controller (not shown) may be associated with one or more of binder jet fabrication subsystem 202, de-powdering subsystem 204, and furnace subsystem 206, etc., and may be configured to receive instructions to form the printed object and to instruct one or more components of system 200 to form the printed object.

FIG. 2B illustrates an exemplary binder jet fabrication subsystem 202 operating in conjunction with build box subsystem 208. Binder jet fabrication subsystem 202 may include a powder supply 220, a spreader 222 (e.g., a roller) configured to be movable across powder bed 224 of build box subsystem 208, a print head 226 movable across powder bed 224, and a controller 228 in electrical communication (e.g., wireless, wired, Bluetooth, etc.) with print head 226. Powder bed 224 may comprise powder particles, for example, micro-particles of a metal, micro-particles of two or more metals, or a composite of one or more metals and other materials.

Spreader 222 may be movable across powder bed 224 to spread a layer of powder, from powder supply 220, across powder bed 224. Print head 226 may comprise a discharge orifice 230 and, in certain implementations, may be actuated to dispense a binder material 232 (e.g., through delivery of an electric current to a piezoelectric element in mechanical communication with binder material 232) through discharge orifice 230 to the layer of powder spread across powder bed 224. In some embodiments, the binder material 232 may be one or more fluids configured to bind together powder particles.

In operation, controller 228 may actuate print head 226 to deliver binder material 232 from print head 226 to each layer of the powder in a pre-determined two-dimensional pattern, as print head 226 moves across powder bed 224. In embodiments, the movement of print head 226, and the actuation of print head 226 to deliver binder material 232, may be coordinated with movement of spreader 222 across powder bed 224. For example, spreader 222 may spread a layer of the powder across powder bed 224, and print head 226 may deliver the binder in a pre-determined, two-dimensional pattern, to the layer of the powder spread across powder bed 224, to form a layer of one or more three-dimensional objects 234. These steps may be repeated (e.g., with the pre-determined two-dimensional pattern for each respective layer) in sequence to form subsequent layers until, ultimately, the one or more three-dimensional objects 234 are formed in powder bed 224.

Although the example embodiment depicted in FIG. 2B depicts a single object 234 being printed, it should be understood that the powder bed 224 may include more than one object 234 in embodiments in which more than one object 234 is printed at once. Further, the powder bed 224 may be delineated into two or more layers, stacked vertically, with one or more objects disposed within each layer.

An example binder jet fabrication subsystem 202 may comprise a powder supply actuator mechanism 236 that elevates powder supply 220 as spreader 222 layers the powder across powder bed 224. Similarly, build box subsystem 208 may comprise a build box actuator mechanism 238 that lowers powder bed 224 incrementally as each layer of powder is distributed across powder bed 224.

In another example embodiment, layers of powder may be applied to powder bed 224 by a hopper followed by a compaction roller. The hopper may move across powder bed 224, depositing powder along the way. The compaction roller may be configured to follow the hopper, spreading the deposited powder to form a layer of powder.

For example, FIG. 2C illustrates another binder jet fabrication subsystem 202′ operating in conjunction with a build box subsystem 208′. In this aspect, binder jet fabrication subsystem 202′ may include a powder supply 220′ in a metering apparatus, for example, a hopper 221. Binder jet subsystem 202′ may also include one or more spreaders 222′ (e.g., one or more rollers) configured to be movable across powder bed 224′ of build box subsystem 208′, a print head 226′ movable across powder bed 224′, and a controller 228′ in electrical communication (e.g., wireless, wired, Bluetooth, etc.) with one or more of hopper 221, spreaders 222′, and print head 226′. Powder bed 224′ may comprise powder particles, for example, micro-particles of a metal, micro-particles of two or more metals, or a composite of one or more metals and other materials.

Hopper 221 may be any suitable metering apparatus configured to meter and/or deliver powder from powder supply 220′ onto a top surface 223 of powder bed 224′. Hopper 221 may be movable across powder bed 224′ to deliver powder from powder supply 220′ onto top surface 223. The delivered powder may form a pile 225 of powder on top surface 223.

The one or more spreaders 222′ may be movable across powder bed 224′ downstream of hopper 221 to spread powder, e.g., from pile 225, across powder bed 224. The one or more spreaders 222′ may also compact the powder on top surface 223. In either aspect, the one or more spreaders 222′ may form a layer 227 of powder. The aforementioned powder delivery and spreading steps may be successively performed in order to form a plurality of layers 229 of powder. Additionally, although two spreaders 222′ are shown in FIG. 2C, binder jet fabrication subsystem 202′ may include one, three, four, etc. spreaders 222′.

Print head 226′ may comprise one or more discharge orifices 230′ and, in certain implementations, may be actuated to dispense a binder material 232′ (e.g., through delivery of an electric current to a piezoelectric element in mechanical communication with binder material 232′) through discharge orifice 230′ to the layer of powder spread across powder bed 224′. In some embodiments, the binder material 232′ may be one or more fluids configured to bind together powder particles.

In operation, controller 228′ may actuate print head 226′ to deliver binder material 232′ from print head 226′ to each layer 227 of the powder in a pre-determined two-dimensional pattern, as print head 226′ moves across powder bed 224′. As shown in FIG. 2C, controller 228′ may be in communication with hopper 221 and/or the one or more spreaders 222′ as well, for example, to actuate the movement of hopper 221 and the one or more spreaders 222′ across powder bed 224′. Additionally, controller 228′ may control the metering and/or delivery of powder by hopper 221 from powder supply 220 to top surface 223 of powder bed 224′. In embodiments, the movement of print head 226′, and the actuation of print head 226′ to deliver binder material 232′, may be coordinated with movement of hopper 221 and the one or more spreaders 222′ across powder bed 224′. For example, hopper 221 may deliver powder to powder bed 224, and spreader 222′ may spread a layer of the powder across powder bed 224. Then, print head 226 may deliver the binder in a pre-determined, two-dimensional pattern, to the layer of the powder spread across powder bed 224′, to form a layer of one or more three-dimensional objects 234′. These steps may be repeated (e.g., with the pre-determined two-dimensional pattern for each respective layer) in sequence to form subsequent layers until, ultimately, the one or more three-dimensional objects 234′ are formed in powder bed 224′.

Although the example embodiment depicted in FIG. 2C depicts a single object 234′ being printed, it should be understood that the powder bed 224′ may include more than one object 234′ in embodiments in which more than one object 234′ is printed at once. Further, the powder bed 224′ may be delineated into two or more layers 227, stacked vertically, with one or more objects disposed within each layer.

As in FIG. 2B, build box subsystem 208′ may comprise a build box actuator mechanism 238′ that lowers powder bed 224′ incrementally as each layer 227 of powder is distributed across powder bed 224′. Accordingly, hopper 221, the one or more spreaders 222′, and print head 226′ may traverse build box subsystem 208′ at a pre-determined height, and build box actuator mechanism 238′ may lower powder bed 224 to form object 234′.

Although not shown, binder jet fabrication subsystems 202, 202′ may include a coupling interface that may facilitate the coupling and/or uncoupling of the build box subsystems 208, 208′ with the binder jet fabrication subsystems 202, 202′, respectively. The coupling interface may comprise one or more of (i) a mechanical aspect that provides for physical engagement, and/or (ii) an electrical aspect that supports electrical communication between the build box subsystem 208, 208′ to the binder jet fabrication subsystem 202, 202′.

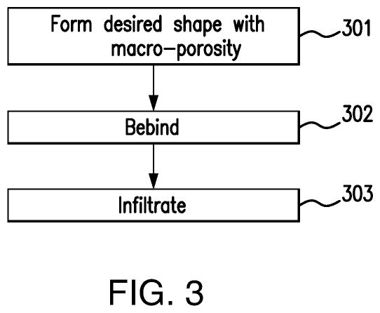

FIG. 3 depicts an embodiment process. In step 301, a build material including a metal powder and a binder system is formed into a skeleton. The skeleton includes graded macro-porosity having a void volume. In step 302, the binder system is at least partially debinded. There may be an additional step of processing for the skeleton, for instance if nitriding of an aluminum alloy is necessary. In step 303, the skeleton is infiltrated with an infiltrant. The infiltrant occupies the void volume of the macro-porosity.

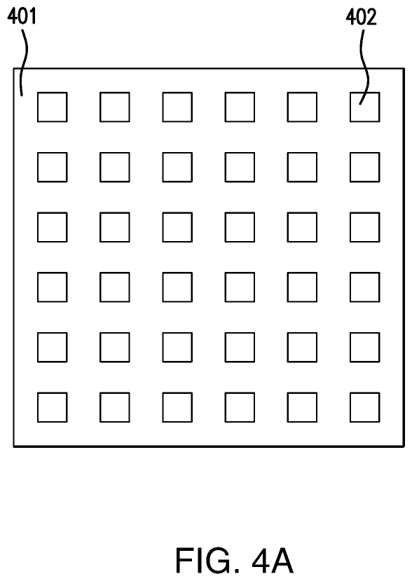

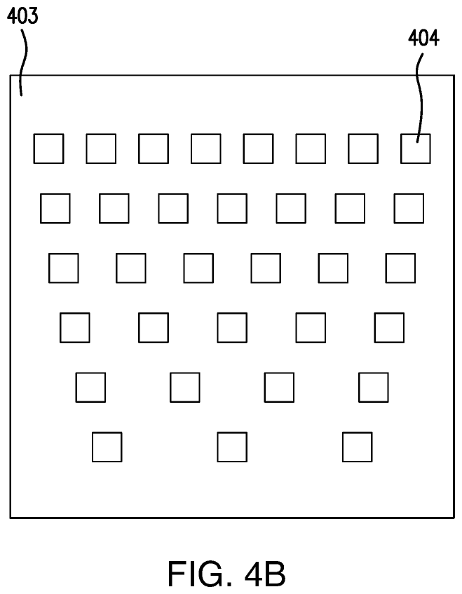

FIG. 4A illustrates a cross-section of an embodiment skeleton 401 formed from build material, the skeleton being in the example a cube. In the embodiment, macro-porosity 402 is formed in the skeleton. It should be understood that the geometry of the part is exemplary, and it should be understood various dimensions and shapes may be employed. Particularly, an infill pattern may be used, either in select portions of the part or throughout the interior of the part, to serve as macro-porosity.

FIG. 4B depicts an embodiment skeleton 403 having macro-porosity 404 that is varied in the volume fraction it represents along a gradient. In the embodiment, the gradient has less macro-porosity in the lower portion of the object and more macro-porosity in the upper portion of the object. This allows the lower portion of the object to enjoy additional support during the manufacturing process. However, other desirable gradients may be readily employed. It has been found that micro-porosity channels on the order of several millimeters can be effectively filled.

FIGS. 5A-C illustrate an embodiment infill structure which may be employed as a graded macro-porosity. FIGS. 5A, 5B and 5C show isometric, top and side views, respectively, of the infill structure. The particular structure is a gyroid, that is a locally infinitely connected triple periodic minimal surface. The infill structure may be incorporated into an additively manufactured skeleton, per the above described systems. The pattern of the infill structure enables infiltration of the network of void space formed by the structure. The size of the pattern may be scaled for use in a given printed object to ensure effective infiltration and the desired volume fraction of infiltrant.

FIGS. 6A-B illustrate another embodiment infill structure which may be employed as graded macro-porosity. FIGS. 6A and 6B show isometric and side views, respectively, of the infill structure. The infill structure may be incorporated into an additively manufactured skeleton, per the above described systems. The pattern of the infill structure enables infiltration of the network of void space formed by the structure. The size of the pattern may be scaled for use in a given printed object to ensure effective infiltration and the desired volume fraction of infiltrant.

FIGS. 7A-B illustrate another embodiment infill structure which may be employed as graded macro-porosity. FIGS. 7A and 7B show isometric and side views, respectively, of the infill structure. The infill structure may be incorporated into an additively manufactured skeleton, per the above described systems. The pattern of the infill structure enables infiltration of the network of void space formed by the structure. The size of the pattern may be scaled for use in a given printed object to ensure effective infiltration and the desired volume fraction of infiltrant. In alternative embodiments, an object may include an infill structure exhibiting other patterns, such as a diamond matrix or a diamond lattice pattern.

Demonstrated Embodiment

Now described is experimentation conducted to demonstrate the disclosed subject matter, particularly the efficacy of infiltrating three-dimensional printed parts. The experimentation concerned an aluminum-based infiltration compatible with the Studio Printing System produced by DESKTOP METAL, INC. of Burlington, Mass. However, one of ordinary skill in the art to which the present disclosure pertains will readily understand that the results of the below described experimentation is applicable to parts manufactured by other systems or methods and in the use of alternative material systems. Further, the conditions under which the experiment was performed should be understood as exemplary and subject to alteration depending on various criteria, including the desired mechanical characteristics of the final part.

The experimental process involved the production of a resin bonded aluminum powder green part, thermal debinding, partial transformation of the aluminum of the part into an interconnected aluminum nitride network, and finally infiltration with a second aluminum alloy.

The primary conclusions of the experimentation were:
1. A three-dimensional printed part may be infiltrated with Al.
2. An advantageous preform alloy was produced containing 6061 aluminum with 2 wt % Mg and 1 wt % Sn. These alloys have a relatively slow, linear nitride growth rate, which is insensitive to gas flow rate and gas purity.
4. Infiltration was performed at 700° C. under vacuum, which was then switched to Ar at the end of the infiltration hold. This generally enhanced the density of the infiltrated part.
5. The achieved mechanical properties, and in particular ductility, were found dependent on the amount of nitride. The best combination of properties demonstrated in final infiltrated parts were a yield strength of ˜100 MPa, a tensile strength of ˜220 MPa and ductility of ˜3.2%.
6. Enhanced ductility was achieved through the incorporation of macro-porosity in green parts as during the infiltration processes the macro-porosity are filled with aluminum without the presence of nitride.

Materials and Experiment Processes

Powders and Feedstocks

There were three different aluminum powders used in the experiment. A metal injection molding (MIM) grade 6061 aluminum from AMPAL, INC. of Palmerton, Penn., a Selective Laser Melting grade 6061 aluminum alloy of LPW TECHNOLOGY INC of Pittsburgh, Penn., and feedstock used to produce 3D printed parts from aluminum feedstock from DESKTOP METAL, INC. of Burlington, Mass. Additions of magnesium and tin were also made to some alloys. The tested three-dimensional printed parts did not contain any magnesium or tin, however this was due only to a lack of immediately available feedstock containing these elements at the time the experiment was performed. Such feedstocks will in the future be readily available, and expected to be mechanically the same or similar to the other tested materials.

The majority of the experimentation was undertaken using cast bars, which were produced from resin bonded powder, as these were easily produced and the results thereof will be applicable to preforms manufactured by a variety of additive manufacturing methods. In this case the resin was a polypropylene powder (SPP-10) from SHAMROCK TECHNOLOGIES, INC. of Newark, N.J. The Magnesium powder used was significantly coarser than desired, and while this this did not seem to have an effect on the process, it would be expected to be advantageous to use finer powder in three-dimensional printing.

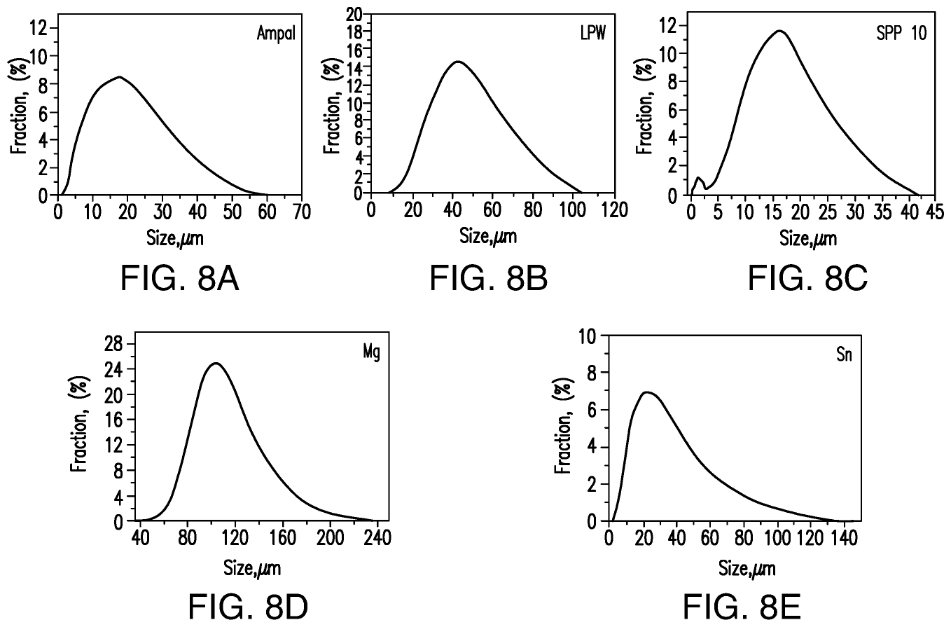

The particle size distribution is shown in FIGS. 8A-E. These are summarized below:

| Powder | d10 (μm) | d50 (μm) | d90 (μm) |
|---|---|---|---|
| Ampal 6061 | 4.8 | 13.5 | 39.9 |
| LPW 6061 | 24.6 | 43.9 | 71.8 |
| 3DP 6061 | — | 14.3 | 33.5 |
| Mg | 78.9 | 104.1 | 143.1 |
| Sn | 6.4 | 22.4 | 73.4 |
| SPP-10 | 2.1 | 14.3 | 26.3 |

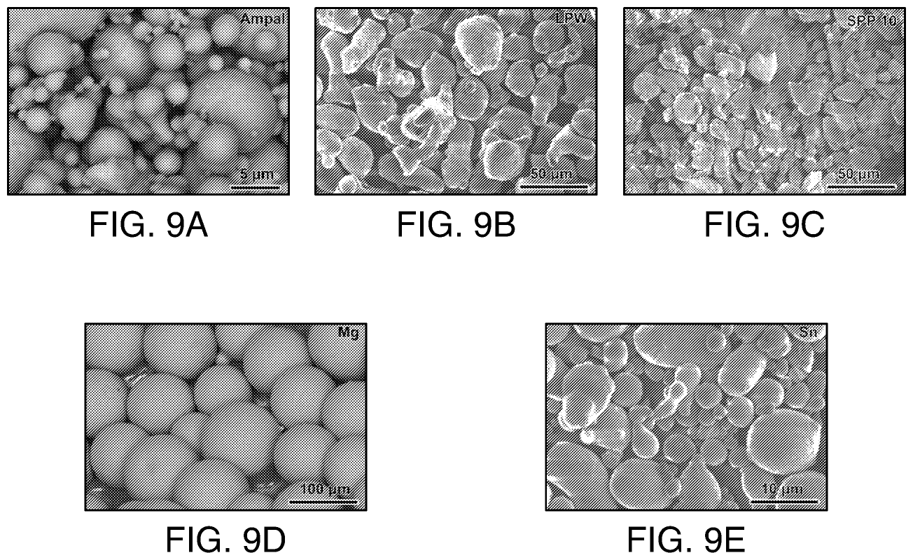

Scanning electron images of the powder are shown in FIGS. 9A-E.

Part Production

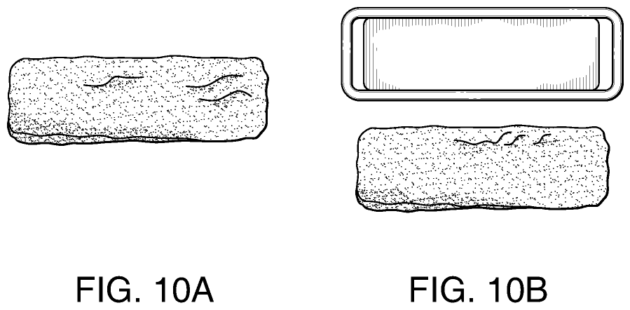

The resin-metal powders mixtures were blended for 30 minutes in a Tubular mixer and then poured into steel molds. These were then heated for 30 minutes at 175° C., which melted the resin to hold the metal powder particles together. On cooling, the cast parts had shrunk slightly and could therefore be removed from the mold, as depicted in FIGS. 10A-B. These cast bars contained 8 wt % of SPP-10 (polypropylene) resin. Some parts were also 3D printed using aluminum feedstock and partially debound.

Furnace and Furnace Cycle

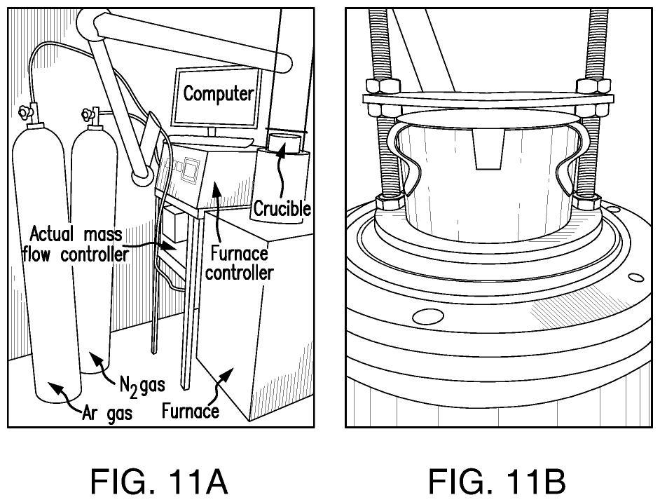

The furnace used in this work was a 3 zone tube furnace, which was fitted with a 160 mm diameter stainless steel tube and gas/vacuum tight end caps, as depicted in FIG. 11A. The furnace was mounted vertically and the crucibles sat on a platform, which was lowered into the furnace as depicted in FIG. 11B.

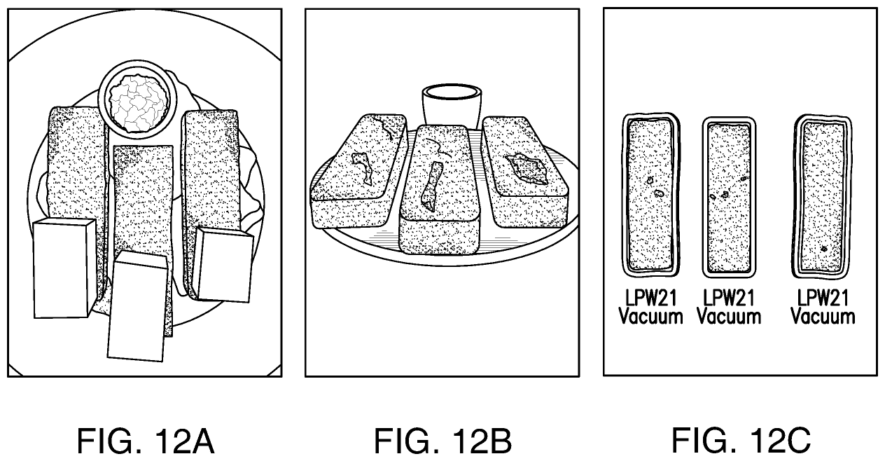

The stainless steel crucibles had a loose fitting lid that contained two 3 mm diameter holes. This allowed removal of the decomposed resin vapor, but contained any Magnesium vapor and limited the exchange of the atmosphere with the part. This is important as an extremely low oxygen content environment is needed to initiate the nitridation reaction. Samples were placed into the crucible, which also contained a small alumina crucible that was filled with Magnesium turnings, as depicted in FIG. 12A. For samples that were to be infiltrated, a block of 6061 was placed at one end. After the furnace cycle, the infiltrant has completely flowed into the preform, as depicted in FIG. 12B, with minimal shrinkage, as depicted in FIG. 12C (infiltrated bars placed back into their respective molds. The bars were 70×20×10 mm.

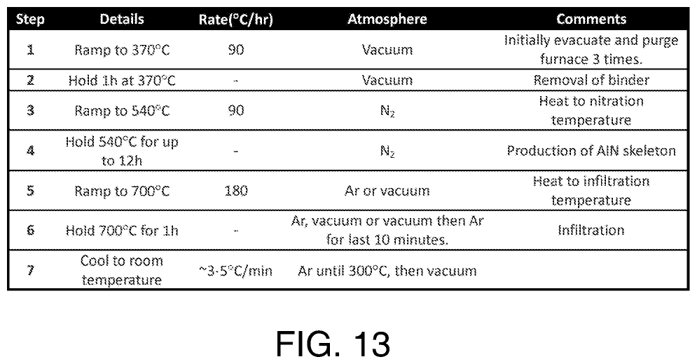

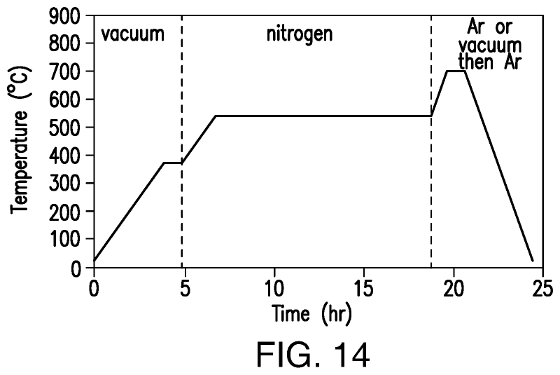

The furnace cycle is summarized in FIG. 13 and shown schematically in FIG. 14. Briefly, the samples were heated at 90° C./hr to 370° C. and held for 1 h under vacuum (via rotary backing pump). The furnace was then back filled with nitrogen (of either high purity or ultra-high purity), and the samples were heated at 90° C./h to 540° C. and held for up to 12 h. The furnace was again evacuated and either back filled with Argon or heated under vacuum to 700° C. (at 180° C./h) for infiltration. For some samples that were heated under vacuum, Argon was introduced in the last 10 minutes of the hold at 700° C. Samples were then cooled to room temperature. The flow rate during the cycle was varied between 0.1 and 1 slpm and was kept the same for both the nitrogen and Argon. The pressure within the furnace was maintained at 1 psig.

Results

Weight Gains Under Different Nitridation Conditions

One of the important factors in the success of the infiltration process for the given material is to first create an interconnected aluminum nitride skeleton. The amount of nitride was determined by measuring the weight increase of the preforms, after taking into account the resin loss. Assuming complete resin removal, a weight gain of ˜5% is usually sufficient for structural integrity during infiltration, while full conversion to AlN results in >30% weight gain. In terms of the effect of powder type, alloy composition, flow rate and gas purity on the weight gain of 6061 preforms, it was found that:
The addition of magnesium and tin results in a slowly growing nitride layer, which is largely insensitive to the gas purity and flow rate.
Pure 6061 aluminum powder tends to form aluminum nitride quickly.
The finer the powder, the more rapid the nitride growth rate.

The Effect of Time

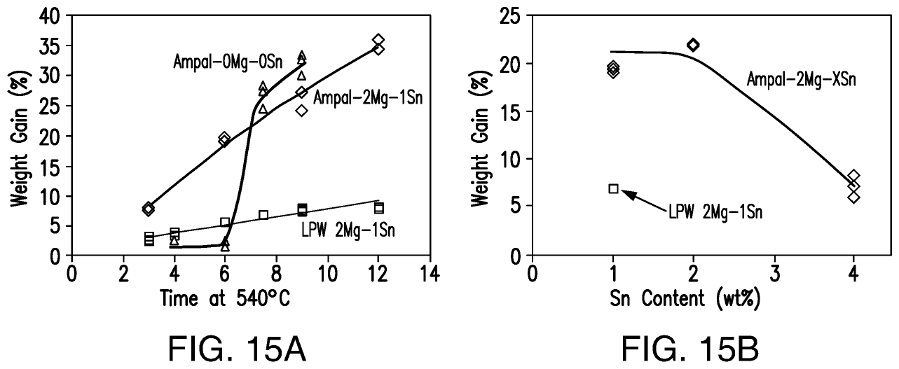

Generally, the amount of nitridation increases with time, as shown in FIG. 15A. For alloys containing magnesium and tin, this relationship is approximately linear. In addition, it can be seen that the finer Ampal powder nitrides significantly quicker than the coarser LPW powder. At longer times, there is little difference between the pure Ampal 6061 aluminum powder and the alloy containing 2% magnesium and 1% tin. Tin is crucial in the control of the nitride growth, while the role of the magnesium is to produce the correct micro-climate within the preform for the aluminum nitride formation. Without magnesium, the addition of tin tends to cause sintering of the preform. The growth of the aluminum nitride is usually located at the interface between the powder particle and nitride layer (see FIG. 19) and therefore the amount of tin required to control the nitride would is dependent on the powder surface area and hence the particle size. FIG. 15B confirms this, with 4% tin being required for the Ampal powder to produce a similar weight gain as the coarser LPW powder with 1% tin. For pure Ampal 6061 powder, there tends to be low or no nitridation, followed by a rapid reaction rate. This makes targeting a defined nitridation level difficult.

The Effect of Gas Purity and Flow Rate

The effect of flow rate and gas purity on the weight gain of the 6061 aluminum preforms is shown in FIGS. 16A-D. The High Purity (HP) gas was 99.99% purity with <10 ppm oxygen and <10 ppm moisture. The Ultra High Purity (UHP) gas was 99.999% purity with <1 ppm oxygen and <2 ppm moisture.

For the pure 6061 alloys (LPW, Ampal and 3D Printed), the weight gain was strongly dependent on the gas flow rate. This was true for both gas purities. For the LPW and 3D printed parts, there appears to be a critical flow rate above which nitridation occurs. For the finer Ampal powder, there is a more gradual, but still significant, increase in the amount of nitridation with flow rate. In contrast, the LPW magnesium-tin alloy is almost insensitive to the flow rate. The gas purity does not change the overall effect of the flow rate and does not have as big an effect on the nitridation as the flow rate. This indicates that the addition of the magnesium turnings to the crucible is successful in acting as a getter and controlling the local oxygen content.

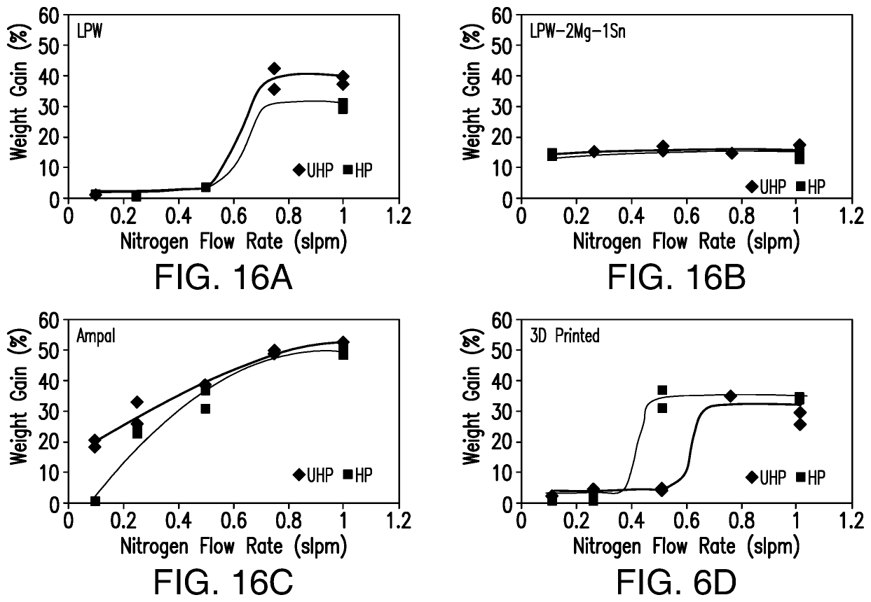

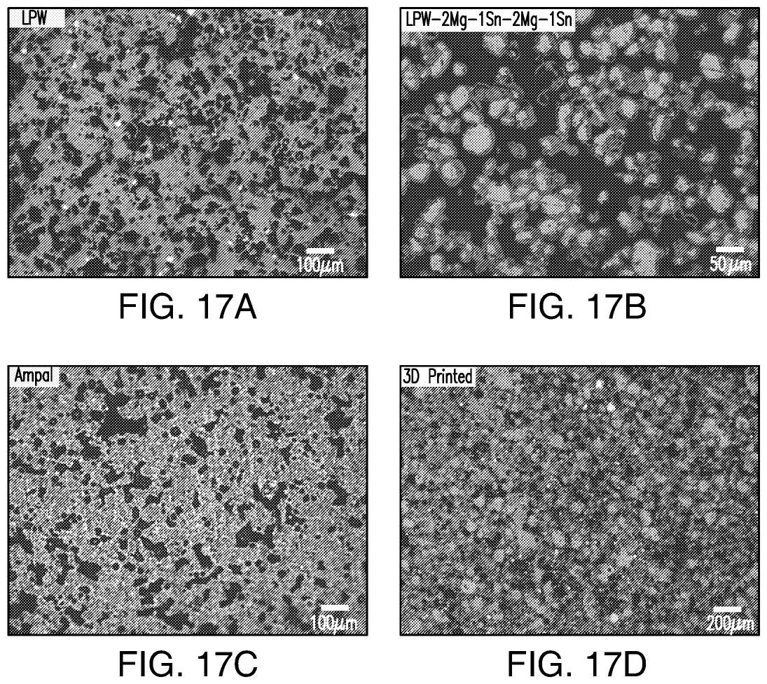

The optical microstructure of the powders after nitriding for 12 h at 540° C. at 1 slpm in UHP N2 are shown in FIGS. 17A-16D. Only the LPW magnesium tin alloy had the desirable structure that consists of an interconnected network of aluminum nitride surrounding the aluminum powder particles. The remaining alloys contain almost pure nitride, with only small areas of aluminum (bright areas) present. This large amount of nitridation also closes off many of the channels that are needed for infiltration.

Infiltration

Infiltration of the preforms was performed at 700° C. At this temperature, the nitride skeleton maintains structural integrity of the preform as both the base powder and infiltrant are both fully molten. Using this approach, it is possible to change the composition (and therefore properties) of the parts by using different infiltrants.

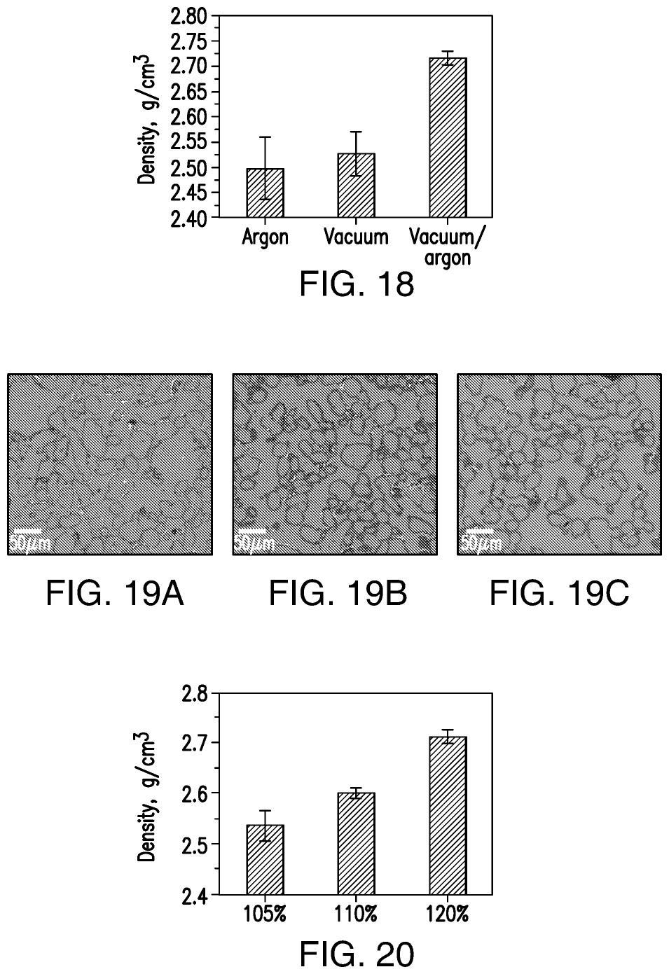

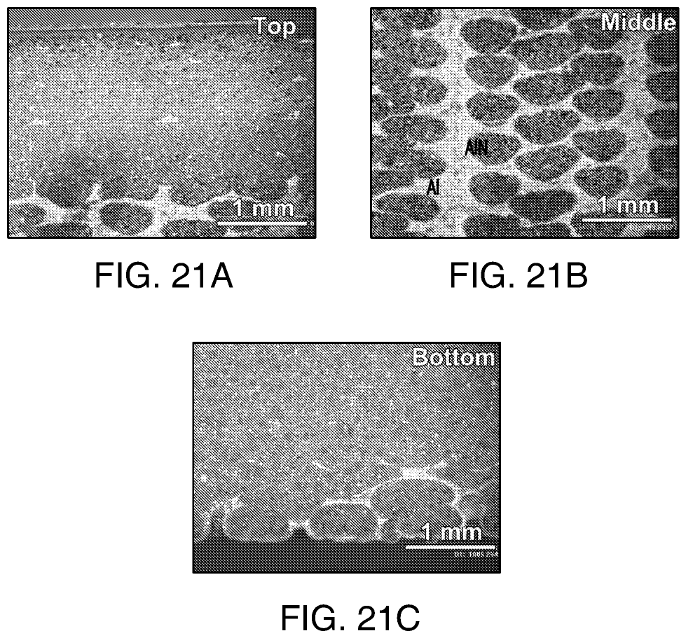

In order to arrest the nitridation reaction, it is critical that the nitrogen be removed from the furnace at the end of the hold at 540° C. and before heating to 700° C. and holding for 1 h. In this work, three different atmospheres were used for infiltration. In all cases the amount of infiltrant was 120% of the weight of the preform. The first was to evacuate the furnace and immediately back fill with argon prior to heating to 700° C. Infiltration was then completed under argon. The second approach used vacuum through the entire infiltration step, while the third evacuated the furnace and heated to 700° C. and held under vacuum for 50 minutes, after which argon was introduced for the last 10 minutes of the 700° C. hold. As can be seen from FIG. 18, the pressure difference created in the third approach enhanced the infiltration, resulting in higher density parts. For example, the filling of the printed infill structure (see FIG. 21) was aid by using the vacuum/argon approach and was not achieved when only using argon or vacuum alone. The microstructure of the infiltrated structure for the LPW magnesium-tin alloy is shown in FIGS. 19A-C, for nitridation times of 6, 9 and 12 h. It is clear from these images that increasing the nitridation time has created an increase in the thickness of the nitride layer. There appears to be little influence of the nitride hold time on the infiltration of these alloys. There is a steady increase in the thickness of the nitride layer (dark phase) with time. The bright contrast areas are tin.

One of the important aspects of the infiltration is to ensure the correct volume of infiltrant is added to the part. Insufficient infiltrant results in large areas of porosity and therefore low properties, while excess infiltrant can bleed out of the part and onto the surface. For cast bars, the optimum amount of infiltrant for the experiment was ˜120% of the weight of the preform, as depicted in FIG. 20.

Infiltration of 3D printed parts was more challenging because these parts contained no magnesium or tin, complete nitridation occurred. Thus infiltration only occurred in the spaces between the print lines and also in the voids created by the in-fill pattern, as shown in FIGS. 21A-C. However, the successful infiltration of these relatively large voids leads to the possibility of using the in-fill pattern to control the properties. This is expanded further in the mechanical property section below.

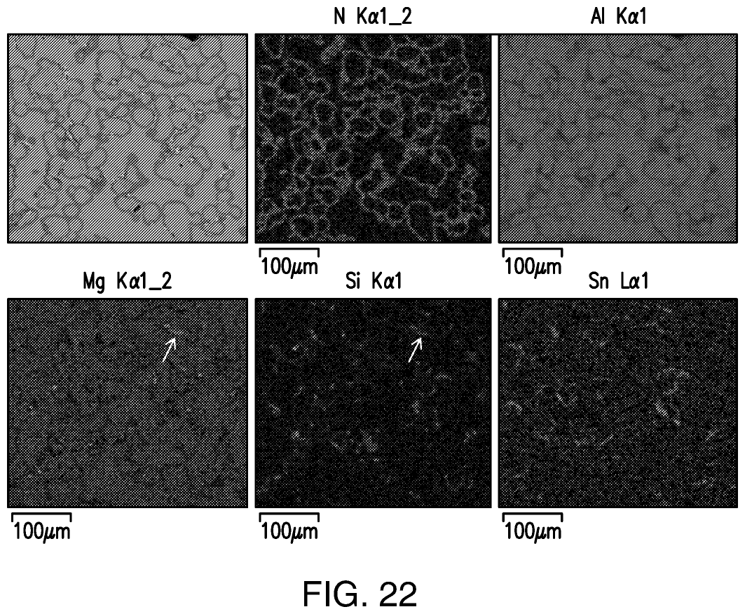

The elemental distribution of the final part was determined using EDS mapping and is shown in FIG. 22, for the sample nitrided for 12 h at 540° C. These maps clearly show the nitride layer. In addition, the regions that are rich in magnesium, also tend to be rich in tin (an example is arrowed). These are likely Mg₂Si particles that have formed during the relatively slow cooling from 700° C. Semi-quantitative elemental analysis of the aluminium matrix suggests that there is ˜2% magnesium present in solution, while the tin content was below the detection limit. These values are consistent with the low temperature solubility limits for magnesium and tin in aluminum, respectively.

Properties

Critical to the success of this alloy system will be the ability to produce acceptable mechanical properties. It has been previous established that the ductility is determined by the amount of nitridation, with low ductility associated with high nitride content. Hence, there is a balance that needs to be made between structural stability (which requires a high amount of nitride) and ductility. The pure 6061 aluminum parts (either cast or 3D printed) completely nitrided during processing to form a porous aluminum nitride structure (see FIG. 9). This meant that they were extremely brittle and fractured during loading into the grips prior to tensile testing. Even 3D Printed parts with an infill structure were not able to be tested.

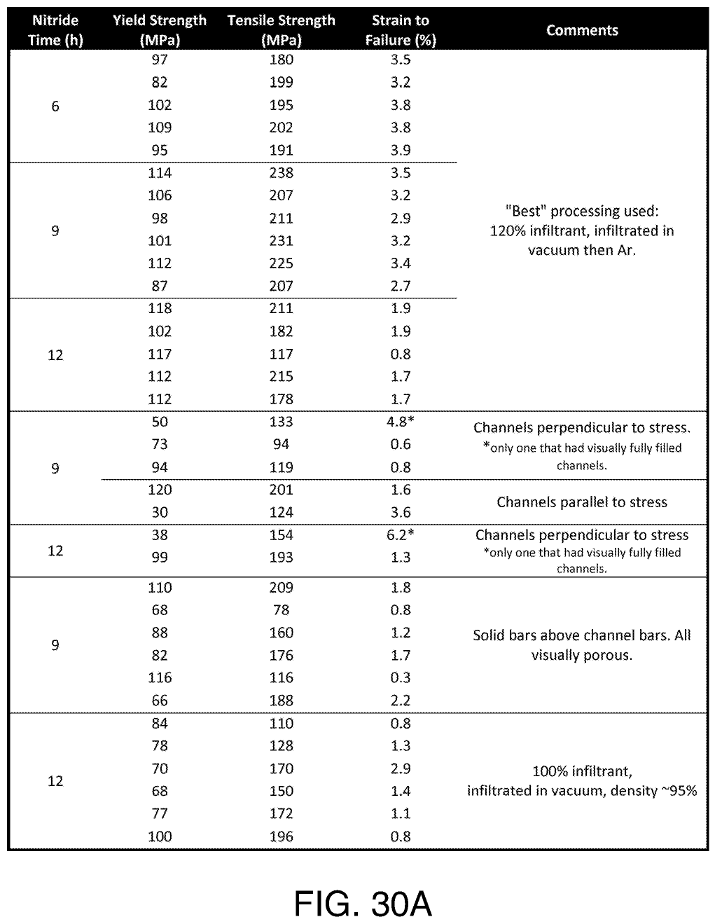

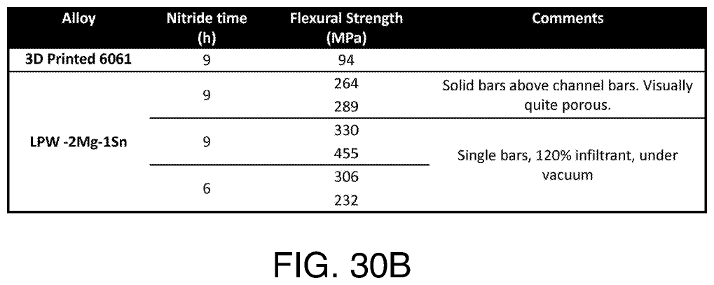

To gain some insight into the properties of the 3D printed bars, a single bar was tested using 3-point bending. The flexural strength was well under half (and in some cases ¼) the strength on LPW magnesium tin case bars. These properties and that of all the tensile tests are summarized in FIGS. 30 and 31. The extremely low properties of the magnesium and tin-free parts are expected to be curable by the addition of these elements to the feedstock used.

The work below was all performed using cast LPW magnesium tin preforms.

Hardness Results

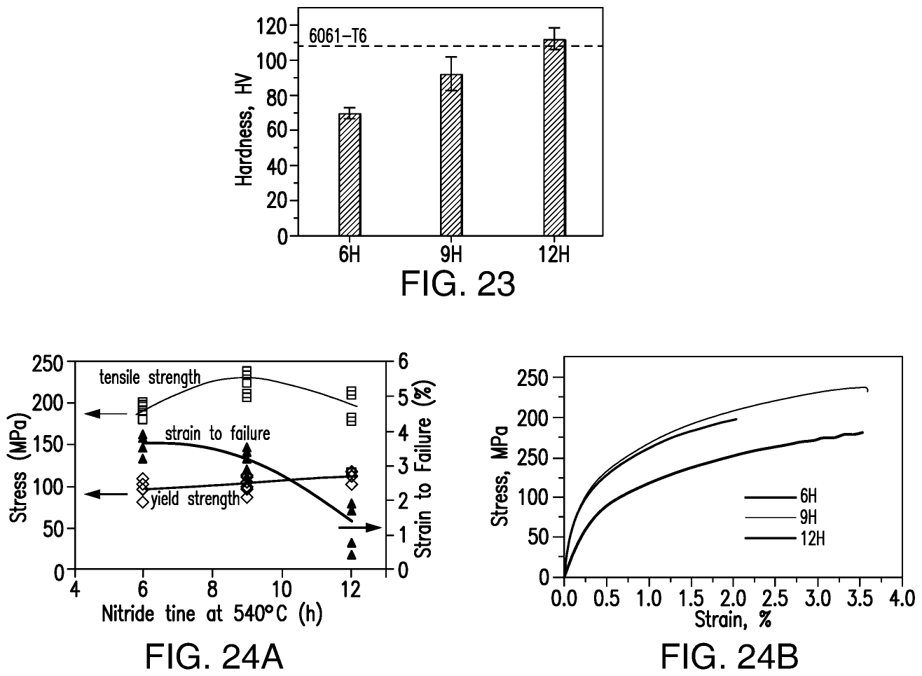

FIG. 23 shows the effect of the nitride hold time (at 540° C.) on the hardness of infiltrated preforms. The longer nitride hold produces more nitride which, similar to conventional metal matrix composites, increases the hardness. These hardness values are in the as-infiltrated condition (slow cooled) and can match that of 6061 aluminum in the T6 condition.

Tensile Properties

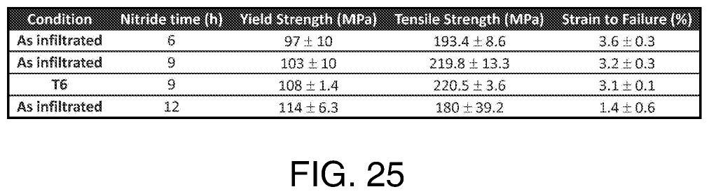

The tensile properties of LPW-2Mg-1Sn which had been nitrided for various times at 540° C. are shown in FIGS. 24A-B, along with typical stress-strain curves. The nitride tends to increase the strength, but reduces the ductility. The (tensile) strength peaks at a 9 h hold, beyond this, the reduction in ductility reduces the tensile strength. The properties achieved are also summarized in FIG. 25. A T6 heat treatment (2 h at 530° C., water quench, 18 h at 160° C.) was performed on bars that had been nitrided for 9 h at 540° C. The strength and ductility were almost identical to the as-infiltrated condition (see FIG. 25), indicating that the heat treatment was not effective. 6061 aluminum age hardens through the precipitation of Mg₂Si. However, the slow cooling from the infiltration temperature results in the formation of coarse Mg₂Si particles. Indeed, the EDS maps shown in FIG. 22 suggests that the Mg rich areas are associated with Si rich areas in the as-infiltrated material. Thus it is possible that the solution treatment time was not sufficient to dissolve these particles and hence aging did not occur.

Increasing the Ductility

There is a limit by which the ductility can be increased via reducing the nitride thickness. At some point, a percolating skeleton does not form and the geometric stability is lost. An alternate way to increase the ductility is to deliberately produce voids in the green part, which would then be filled by the infiltrant. Since these volumes would not contain any aluminum nitride, they should enhance the ductility. Macro-porosity in the form of channels were produced in parts via the addition of thin plates to the mold. These plates were then removed and a second full bar was placed on top. After infiltrating, the bars were cut in two (the lower section contained the channels, while the top section did not) and then the parts were machined into tensile bars.

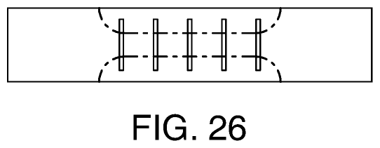

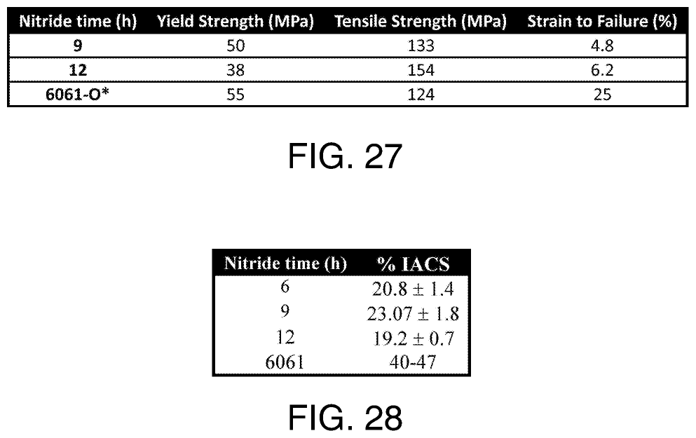

Schematically, this is shown in FIG. 26. During tensile testing, the orientation of these channels relative to the tensile direction would mean that the material in a condition of iso-stress. That is, the stress in all parts of the bar is constant and therefore the expectation was that the filled channels will contribute to increased ductility. The filling of these channels was somewhat problematic, as it was difficult to determine the amount of infiltrant required. The more predictable and reproducible 3D printing process should overcome these difficulties. Only one bar that had been nitrided for 9 h and one bar at 12 h was able to be produced in which the channels had completely infiltrated. These bars had the highest ductilities ever measured in infiltrated parts; 4.8 and 6.2%, respectively—see FIG. 27. Also shown in this Table is the data from annealed 6061-O (annealed). The strength of these bars is very low, which was to be expected as the channels will be almost pure, slow cooled 6061 aluminium. Indeed, the strength is similar to the handbook values the strength of the part annealed 6061. This approach has significant potential to enhance the ductility of the infiltrated parts.

Electrical Conductivity

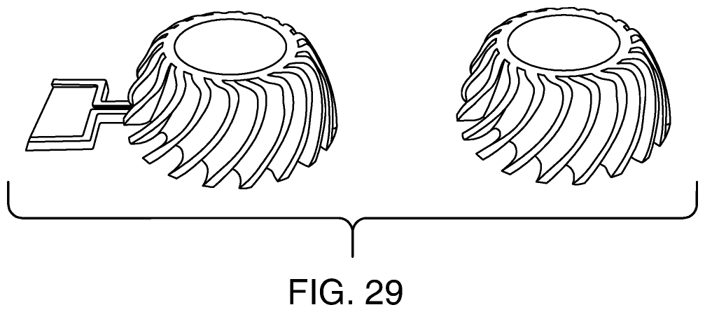

Electrical conductivity was measured using a handheld eddy current probe. The results, along with that for wrought 6061 are presented in FIG. 28. These measurements were done on the ends of the tensile bars reported in FIG. 17 and FIG. 25 and were performed on at least 6 samples. Despite differences in the amount of nitride, the nitride hold time did not seem to have a big effect on the conductivity and all samples were approximately half that of 6061.

3.4 Demonstration Part

A 3D printed impeller (inner diameter of 30 mm) was infiltrated using a 12 h hold at 540° C. and then 1 h at 700° C., as depicted in FIG. 29, before and after the removal of an infiltration tab. The part came out of the furnace looking bright and shiny and appeared to be dimensionally stable. There was a small amount of bleed out into the root of the impellor blades. This indicates that there was slightly too much infiltrant added.

Summary

In summary, it was confirmed there is an ability to produce dimensional stable infiltrated aluminum preforms. Specifically, it was shown:
The growth of the nitride was controllable and approximately linear for alloys containing magnesium and tin. Without magnesium and tin, nitridation occurred very rapidly.
Addition of magnesium and tin made the processing insensitive to gas flow rate and gas purity
Infiltration occurred at 700° C.
Infiltrating under vacuum then switching to argon near the end resulted in the best density parts.
thee-dimensionally printed magnesium and tin-free parts were infiltrated, including the macro-porosity created by the in-fill pattern.
A 9 hour nitride hold produced optimum properties, with a yield strength of ˜100 MPa, tensile strength of ˜220 MPa and ductility of ˜3.2%.
Performing a T6 heat treatment did not increase the strength of the material, likely due to the stability of the large Mg₂Si particles that form.
Adding macro-porosity in the form of channels to the parts resulted in an increase in ductility. It was found that the addition of tin and magnesium greatly aided in producing a wide processing window and were advantageous for the tested material system.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. A method of fabricating a metallic three-dimensional object of a desired shape, comprising the steps of:
forming a build material into a skeleton of the desired shape of the three-dimensional object, the build material including a metal powder and a binder system;
wherein the skeleton includes graded macro-porosity having a void volume;
debinding at least a portion of the binder system; and
infiltrating the skeleton with an infiltrant wherein the void volume of the macro-porosity is filled with the infiltrant.

2. The method of claim 1 wherein the void volume of the graded macro-porosity in a first section of the skeleton is a first volume fraction of the skeleton that is higher than a second volume fraction of the skeleton in a second section.

3. The method of claim 1 wherein the void volume of the graded macro-porosity varies as a volume fraction of the skeleton in at least one axis.

4. The method of claim 1 wherein the void volume of the graded macro-porosity varies as a volume fraction of the skeleton in at least two axes.

5. The method of claim 1 wherein the void volume of the graded macro-porosity varies as a volume fraction of the skeleton in at least three axes.

6. The method of claim 1 wherein the step of forming the build material into a skeleton includes bound metal deposition additive manufacturing.

7. The method of claim 6 wherein the macro-porosity in the skeleton is introduced by controlling at least one parameter in the bound metal deposition additive manufacturing.

8. The method of claim 7 wherein the macro-porosity in the skeleton is introduced by manipulating a tool pathing of a nozzle.

9. The method of claim 1 wherein the step of forming the build material into a skeleton includes powder bed binder jetting additive manufacturing.

10. The method of claim 9 wherein the macro-porosity in the skeleton is introduced by controlling at least one of a droplet size and a binder saturation.

11. The method of claim 1, wherein the metal powder is an aluminum alloy, the infiltrant is aluminum, and further comprising the step of nitriding the aluminum alloy prior to infiltration.

12. The method of claim 1 wherein the void volume of the graded macro-porosity is defined by a gyroid infill pattern.

13. A method of fabricating a metallic three-dimensional object of a desired shape, comprising the steps of:
depositing a plurality of successive layers of build material to form a skeleton having graded macro-porosity, wherein the build material includes a binder system and a metal powder;
removing at least a portion of the binder system;
infiltrating the skeleton with an infiltrant to fill at least a portion of a void volume of the graded macro-porosity; and
wherein the metal powder is a first metal alloy and the infiltrant is a second metal alloy.

14. The method of claim 13 wherein the void volume of the graded macro-porosity varies as a volume fraction of the skeleton in at least one axis.

15. The method of claim 13 wherein the macro-porosity in the skeleton is introduced by controlling at least one parameter in a bound metal deposition additive manufacturing process.

15. The method of claim 13 wherein the macro-porosity in the skeleton is introduced by controlling at least one parameter in a powder bed binder jetting additive manufacturing process.

17. A method of fabricating a metallic three-dimensional object of a desired shape, comprising the steps of:
additively manufacturing a skeleton of an aluminum alloy and binder system having a graded macro-porosity;
removing at least a portion of the binder system;
nitriding the aluminum alloy to form an aluminum nitride skeleton;
infiltrating the aluminum nitride skeleton with aluminum wherein a void space of the macro-porosity is occupied by aluminum.

18. The method of claim 1 wherein the void volume of the graded macro-porosity varies as a volume fraction of the skeleton in at least one axis.

19. The aluminum nitride skeleton is dimensionally stable in the presence of the infiltrant during an infiltration process effective to infiltrate the void space of the macro-porosity.

20. The method of claim 17 wherein the void volume of the graded macro-porosity is defined by a gyroid infill pattern.
